(19) United States
(12) Patent Application Publication
(10) Pub. No.: US 2012/0105126 A1
(43) Pub. Date: May 3, 2012

(54) DEVICE AND METHOD FOR STORING AND RETRIEVING OR FOR INCREASING PERSISTENCE TIME IN MEMORY STORAGE FOR ONE OR MORE BINARY DIGITS THROUGH STOCHASTIC RESONANCE

(76) Inventors: Roberto Pedro José PERAZZO, Olivos (AR); Diego Fernando Grosz, Olivos (AR); Pablo Ignacio Fierens, Ciudad de Buenos Aires (AR); Santiago Agustín Ibáñez, San Carlos de Bariloche (AR); Germán Agustín Patterson, Ciudad de Buenos Aires (AR)

(21) Appl. No.: 12/915,669

(22) Filed: Oct. 29, 2010

(51) Int. Cl. G06G 7/12

(52) U.S. Cl. 327/355

(57) ABSTRACT

The present invention refers to a device for storing and retrieving one or more binary digits or for increasing persistence time of memory storage for one or more binary digits through Stochastic Resonance, comprising:
a. a circuit with at least one bistable element;
b. means for introducing an input signal into the circuit;
c. means for introducing an adequate amount of noise signal into the circuit and/or means for adjusting the thresholds of the bistable elements and/or means for adjusting the output levels of the bistable elements, whereby the input signal, added to the noise signal, surpasses the transition thresholds, and
d. means for detecting the output signal state.

The invention is based on the surprising fact that it is possible to store one or more binary digits in a system capable of using existing and inevitable noise in the system advantageously for storage purposes.

### BACKGROUND OF THE INVENTION

The increasing capacity of modern computers has been driven by Moore's Law, which postulates that the maximum number of transistors in an integrated circuit doubles every two years. However, higher transistor density and power consumption require the use of smaller supply voltages. All these factors together lead to smaller noise margins and higher error rates in computation. (L. B. Kish. Moore's law and the energy requirement of computing versus performance. IEE Proceedings—Circuits, Devices and Systems, 151(2):190-194, April 2004).

There have been several proposals to solve this problem, e.g. taking explicitly into account the fact that the results may be correct only with some probability, (P. Korkmaz, B. E. S. Akgul, y K. V. Palem. Energy, performance, and probability tradeoffs for energy-efficient probabilistic CMOS circuits. Circuits and Systems I: Regular Papers, IEEE Transactions on, 55(8):2249-2262, September 2008. K. V. Palem. Energy aware computing through probabilistic switching: a study of limits. Computers, IEEE Transactions on, 54(9):1123-1137, September 2005. R. I. Bahar, J. Mundy, and Jie Chen. A probabilistic-based design methodology for nanoscale computation. In Computer Aided Design, 2003. ICCAD-2003. International Conference on, pages 480-486, November 2003.), and using an orthogonal set of noise processes for representing logical values (L. B. Kish. Noise-based logic: Binary, multi-valued, or fuzzy, with optional superposition of logic states. Physics Letters A, 373(10):911-918, 2009). There are also systems or methods for reducing noise or its harmful effects, as illustrated for example by patent applications JP 2006-013536, KR 20080085409 and US 2009/0073793 and U.S. Pat. No. 7,685,480. Recently, it has been shown the way to implement basic logical operations (OR, AND, NOR, NAND) using nonlinear systems to improve their performance in presence of noise: a signature of stochastic resonance. K. Murali, S. Sinha, W. L. Ditto, and A. R. Bulsara. Reliable logic circuit elements that exploit nonlinearity in the presence of a noise floor. Phys. Rev. Lett., 102(10):104101, 2009.

Stochastic resonance is usually associated with a nonlinear system where noise helps an otherwise weak signal to induce transitions between stable equilibrium states (R. Benzi, A. Sutera, and A. Vulpiani. The mechanism of stochastic resonance. J. Phys. A, 14:L453, 1981. B. McNamara and K. Wiesenfeld. Theory of stochastic resonance. Phys. Rev. A, 39:4854-4869, 1989. L. Gammaitoni, P. Hänggi, P. Jung, and F. Marchesoni. Stochastic Resonance. Rev. Mod. Phys., 70:223-287, 1998). The phenomenon of stochastic resonance has been studied in a large number of applications, ranging from biological and neurological systems, information transmission sustained by noise to storage of harmonic signals (M. F. Carusela, R. P. J. Perazzo, and L. Romanelli. Stochastic resonant memory storage device. Phys. Rev. E, 64, 2001. M. F. Carusela, R. P. J. Perazzo, and L. Romanelli. Information transmission and storage sustained by noise. Physica D, pages 177-183, 2002. M. F. Carusela and L. Romanelli. Phase behavior in a ring of stochastic oscillators. Advances in Complex Systems (ACS), 11(01):55-64, 2008). A ring of identical oscillators was thereby shown to be able to sustain a travelling wave with the aid of noise, long after the harmonic drive signal had been switched off.

### BRIEF DESCRIPTION OF THE INVENTION

An object of the present invention is the storage of one or more binary digits in a system capable of advantageously using the inevitable existing noise in the system for storage purposes.

According to the present invention, noise helps a memory device to, for example, improve its performance, minimizing error probability and increasing the stored information persistence time. This contrasts with the general context as that presented by Moore's law: the growing integration scale (density) of electronic devices causes the amplitude of the carrying information signals to be comparable to the existing noise levels, a situation that, in most cases, leads to performance degradation.

Furthermore, even the addition of an adequate amount of noise to a system has been proved convenient for storing one or more binary digits, contrary to what an expert in the art might have foreseen.

Besides, and also unexpectedly, the existence of a noise range with optimum storage persistence has been found.

Consequently, an object of the present invention includes a device for storing and retrieving one or more binary digits or for increasing persistence time of memory storage for one or more binary digits through Stochastic Resonance, comprising:
a. a circuit with at least one bistable element;
b. means for introducing an input signal into the circuit;
c. means for adjusting the noise level and/or transition thresholds of the bistable elements and/or output levels of said elements, whereby the input signal, added to the noise signal, surpasses the transition thresholds; and
d. means for detecting the output signal state.

An unexpected advantage of the present invention is that the device allows the storage of one or more binary digits in a circuit comprising at least two bistable elements, even when the coupling between the bistable elements is not strong enough to allow propagation of state changes in the absence of noise.

In this way, the device claimed in this invention uses noise “smartly”, regardless if noise was added ad hoc or is inherent to the system. Then, instead of considering noise as an unavoidable drawback, it is considered as an element that may allow for and help the system operation.

In one of the preferred embodiments of the present invention, said adjusting means are means for introducing an adequate amount of noise signal into the circuit.

In another preferred embodiment of the present invention, said adjusting means are means for adjusting the transition thresholds of the bistable elements according to the noise level existing in the system.

In yet another preferred embodiment of the present invention, said adjusting means are means for adjusting the output levels of the bistable elements according to the noise level existing in the system.

In another embodiment of the present invention, the device comprises means for introducing an adequate noise signal, means for adjusting the transition thresholds of the bistable elements and means for adjusting the output levels of the bistable elements according to the noise level in the system.

In a preferred embodiment, the device for storing and retrieving one or more binary digits through Stochastic Resonance of the invention comprises:
a. a circuit with at least one bistable element;
b. means for introducing an input signal into the circuit;
c. means for introducing an adequate amount of noise signal into the circuit for surpassing, added to the input signal, the input threshold, if needed, and/or for improving the storage persistence time; and
d. means for detecting the output signal state.

In yet another preferred embodiment of the invention, bistable elements are connected in a loop configuration.

In yet another more preferred embodiment of the invention, bistable elements are Schmitt Triggers.

In another preferred embodiment of the invention, the input signal is a finite duration signal.

In even another preferred embodiment of the invention, the device comprises means for introducing an adequate amount of noise signal into the input of each bistable element.

In yet another preferred embodiment of the invention, the noise signal is Gaussian noise.

In another preferred embodiment, the device for storing and retrieving one or more binary digits through Stochastic Resonance of the invention comprises:
a. a circuit comprising at least one bistable element arranged in a loop configuration;
b. means for introducing an input signal into the circuit;
c. means for introducing an adequate amount of noise signal into the circuit for surpassing, added to the input signal, the input threshold, if needed, and/or for improving the storage persistence time;
d. means for delaying the signal; and
e. means for detecting the output signal state.

In another preferred embodiment, the device of the present invention comprises:
a. a circuit with at least one bistable element;
b. means for introducing an input signal into the circuit;
c. means for adjusting the thresholds and/or the output levels of the bistable elements in such a way as to take advantage of the noise present in the system;
d. means for delaying the signal; and
e. means for detecting the output signal state.

Preferably, in the preceding embodiment of the invention, bistable elements are Schmitt Triggers.

Again, preferably, in the preceding embodiment of the invention, the input signal is a finite duration signal.

Again, preferably, in the preceding embodiment of the invention, the device comprises means for introducing an adequate amount of noise signal into the input of each bistable element.

Again, preferably, in the preceding embodiment of the invention, the noise signal is Gaussian noise.

Another object of the present invention consists of a method for storing and retrieving one or more binary digits or for increasing persistence time of memory storage for one or more binary digits through Stochastic Resonance, in a circuit comprising at least one bistable element, introducing an input signal, adjusting the noise level and/or the thresholds and/or the output levels of the bistable elements, whereby the input signal, added to the noise signal, surpasses the transition thresholds; and detecting the circuit output signal.

In an embodiment of the invention, said adjustment comprises the introduction of a noise signal into the circuit.

In yet another preferred embodiment of the invention, said adjustment comprises the adjustment of transition thresholds of the bistable elements, according to the noise existing in the system.

In yet another preferred embodiment of the invention, said adjustment comprises the adjustment of the output levels of the bistable elements, according to the noise existing in the system.

In preferred embodiments of the present invention, said adjustment comprises a combination of two or of all three embodiments indicated in the preceding paragraphs.

In a preferred embodiment of the method of the invention, said input signal is below input threshold.

In another preferred embodiment of the method of the invention, said input signal surpasses the input threshold.

In yet another preferred embodiment of the method of invention, the method further comprises delaying the signal.

In yet another more preferred embodiment of the method of the invention, said bistable elements are Schmitt Triggers.

In yet another preferred embodiment of the method of the invention, said input signal is a finite duration signal.

In yet another preferred embodiment of the method of the invention, the coupling between bistable elements, or the self-coupling in the case of a single bistable element in a loop configuration, is not strong enough to force transitions between output states of the bistable elements and said adequate amount of noise signal is introduced at the input of each bistable element.

In a most preferred embodiment of the method of the invention, said noise signal is Gaussian noise.

### BRIEF DESCRIPTION OF THE FIGURES

FIG. 1 shows the representation of a bistable element, as it is shown in any of the FIGS. 4 to 7.

FIG. 2 shows a scheme of a delay generator, as it is shown in any of the FIGS. 4 to 7.

FIG. 3 schematically represents a noise generator, as it is shown in any of the FIGS. 4 to 7.

FIG. 4 shows a storage device of one or more bits according to the invention.

FIG. 5 shows a storage device of FIG. 4 including a delay generator.

FIG. 6 shows a device such as that of FIG. 4, where noise is added at the input of each bistable element in order to allow the storage of one or more bits.

FIG. 7 shows a device such as that of FIG. 5, where noise is added at the input of each bistable element in order to allow the storage of one or more bits.

### DETAILED DESCRIPTION OF THE INVENTION

The invention will be now explained in detail with reference to the enclosed figures.

An object of the present invention includes a device for storing and retrieving one or more binary digits or for increasing persistence time of memory storage for one binary digits through Stochastic Resonance, comprising:
a. a circuit with at least one bistable element;
b. means for adjusting the noise level and/or the thresholds of the bistable elements, whereby the input signal, added to the noise signal, surpasses the thresholds;
c. means for introducing an adequate amount of noise signal within the circuit; and
d. means for detecting the output signal state.

According to the present invention, a bistable element or device is an electronic circuit having an input and an output. The output can only have two values, Sₒ₁ y Sₒ₂. The input value will determine the output state from the two possible states.

Adequate preferred bistable elements for use in storage devices of the present invention correspond to two basic types of bistable: comparators and Schmitt triggers (STs). A Schmitt trigger is a bistable circuit whose basic functioning is characterized by two possible output values, Sₒ₁ and Sₒ₂ and two input thresholds, U₁<U₂. An ST output changes from state Sₒ₂ to Sₒ₁ if the input is below U₁. On the other hand, its state changes from Sₒ₁ to Sₒ₂ if the input is above U₂.

A comparator can be considered a particular case of a ST where the two thresholds collapse in one. That is, in a comparator only a single threshold U exists; the comparator output being Sₒ₁ if the input is above U and Sₒ₂ if it is below U.

A signal is said to be sub-threshold regarding a Schmitt trigger, if:
the signal is enclosed within two values m and M so that m≦M, and
U₁≦m≦M≦U₂.

Furthermore, a signal is said to be sub-threshold as it regards a comparator if
the signal is enclosed below value of m and U<m, or if
the signal is enclosed above value of M and M<U.

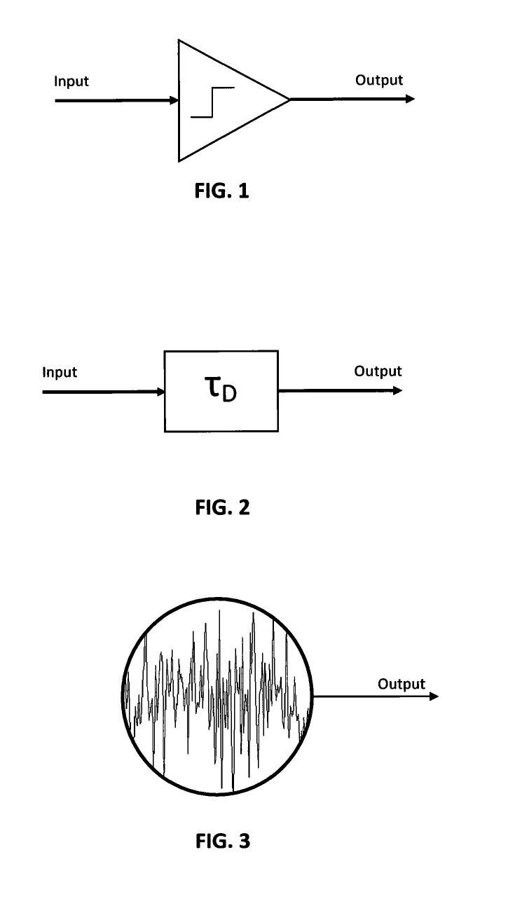

FIG. 1 shows a bistable element, as it is represented in any of the figures.

Bistable elements correspond to known circuits. The above is a simplified definition for bistable elements according to the present invention, as it does not consider the complex dynamic behavior of said systems. That is to say that the description provided for the bistable elements is quasi-static, i.e. assuming sufficiently long observation periods of input and output signal without getting into details on the dynamics of the state changes of the bistable elements and/or means for adjusting transition thresholds between bistable elements states, according to the noise level existing in the system/elements.

FIG. 2 shows a scheme of another constitutive element of the storage device of this invention, generically known as delay generator, as it is represented in any of the figures. Said delay generator has an input and an output. The output is a delayed copy of the input in a set amount of time.

FIG. 3 shows a scheme of another constitutive element of the storage device of this invention, called noise generator, as it is represented in any of the figures.

The invention will be further described in the following preferred embodiments.

### EXAMPLE 1

FIG. 4 shows a storage device of one or more bits, according to one embodiment of the present invention.

The device consists of a chain formed by one or more similar bistable elements forming a loop. The input signal can consist of one or more binary digits, i.e. the information meant for storage is coded through an amplitude coding system. The input signal can be supra-threshold respect of the first bistable device in the chain. Stored information can be recovered through a detection system at the output of any bistable element. Since the number of bits stored and the duration of each one are fixed known parameters, a possible detection way consists of averaging the output value during a fraction of the time interval corresponding to each binary digit and comparing said average with a threshold.

The duration of each coded binary digit and the number of coded binary digits depend among other factors on the bistable devices response time and the propagation time of a signal along the chain. On the one hand, relevant changes in the input signal must be produced at intervals long enough to allow bistable elements to respond. On the other hand, in order to store more than one binary digit, the time duration for the binary digits sequence must be shorter than or equal to the signal propagation time along the whole chain.

Noise constitutes another factor affecting duration of each binary digit and the number of digits that can be stored, and particularly its intensity and temporal and spectral features.

According to the present invention, noise is considered in this scheme as having the following characteristics:
Noise is present in the system and is unavoidable.
Noise amplitude is comparable to the output signal levels allowed in bistable elements according to the specific technology used to build the device.

According to the present invention, the storage device allows for a novel and unexpected use of the noise existing in the system for storing purposes, through:
1. Adjusting output levels of bistable elements and/or of their thresholds, according to the existing noise, in such a way as to allow storing one or more binary digits, optimizing at the same time the storage device performance as memory.
2. Setting the adequate duration of each binary digit and the number of digits that can be stored, considering not only the storage device features but also the existing noise below signal level and threshold adjustment mode as specified in 1 above.

In the particular example of the storage of a single bit, the starting point is a system with existing Gaussian noise, having a constant density power spectrum, i.e., a flat, essentially flat power spectrum (variation of less than 3 dB) having a bandwidth Bnoise=10-20 kHz, with a 0.4 V² variance. In order for the noise to be considered “white” its correlation time (Tcorr˜1/Bnoise) must be much shorter (e.g. 10 times) than the duration of the stored bit (e.g. 1 ms) and, in general, much shorter than any relevant time scale of the system. However, the device operation principle is the same even when this condition is not met. That is, the device can operate keeping the features described in the application in the presence of “white” noise (uniform spectral distribution) or of “colored” noise (non-uniform spectral distribution).

As preferred bistable elements two STs are used having thresholds set at U₁=−1 V, U₂=3 V, and output levels Sₒ₁=0 V, Sₒ₂=+2 V. In order to store one information bit, a 1 ms duration pulse and +5 V or −3 V amplitude, respectively, is injected to the input of one of the Schmitt triggers, depending on if a “1” or a “0” is meant for storage. Detection is carried out as follows:
1. the output of any ST is averaged during 1 ms;
2. said average is compared to a threshold fixed in 1 V, so as to decide if the stored bit is a “1” if the average is higher than threshold, or a “0” in the opposite case.

### EXAMPLE 2

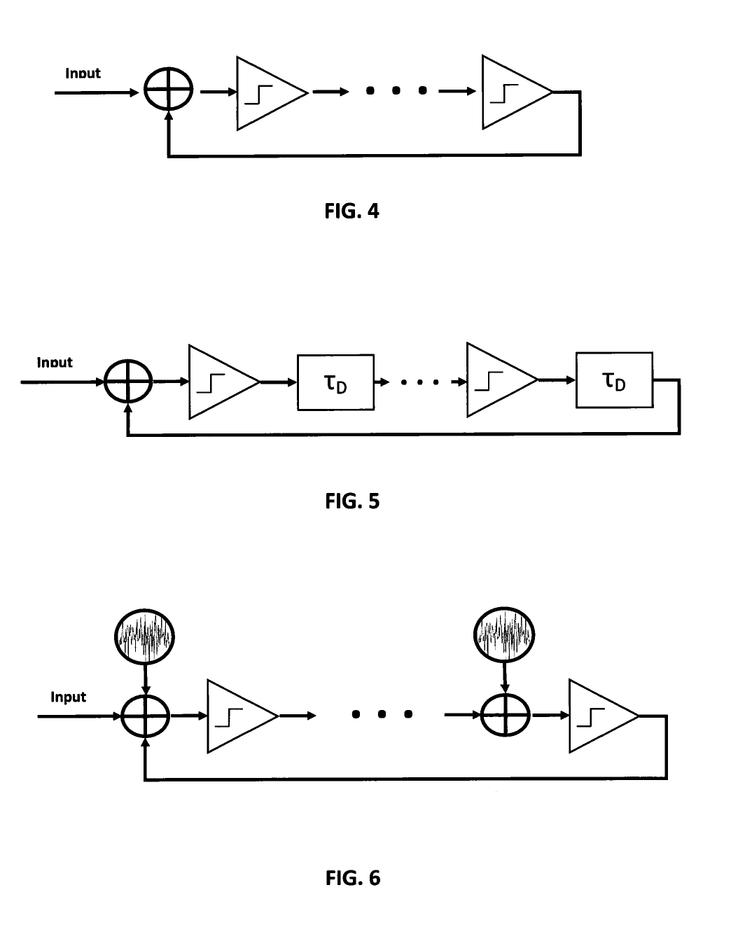

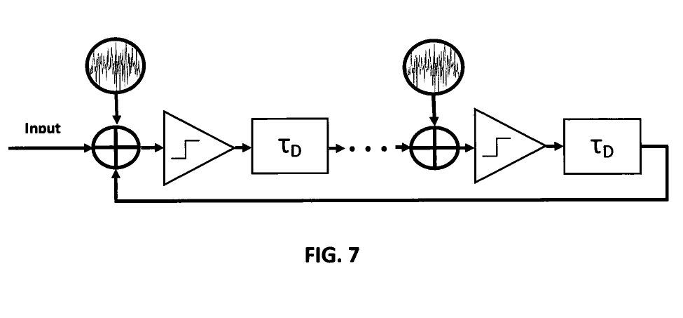

FIG. 5 shows a storage device of one or more bits, according to another embodiment of the present invention.

This outline is similar to the storage device of Example 1, differing in that one or several delay generators are added, their number not being related to the number of bistable elements in the chain. The aim of the delay generators is to allow an increase in the number of binary digits that can be stored in the memory. The delay generator can consist for example of a transmission line sufficiently long for the signal transit time to be noticeable.

Similarly to Example 1, according to the present invention, noise is considered as having the following characteristics:
Noise is present in the system and is unavoidable.
Noise amplitude is comparable to output signal levels of bistable elements.

According to the example of the present invention, the storage device allows a novel and unexpected use of noise present in the system for storing purposes, through:
1. Adjusting output levels of bistable elements and/or their thresholds, according to the existing noise, in such a way as to allow storing one or more binary digits, optimizing at the same time the storage device performance as memory.
2. Setting the adequate duration of each binary digit and the number of digits that can be stored, considering not only the storage device features but also the existing noise level and threshold adjustment mode as specified in 1 above.

In this particular example, the starting point is a system with existing Gaussian noise, having a constant density power spectrum, i.e., a flat, essentially flat power spectrum (variation of less than 3 dB) having a bandwidth Bnoise=100-200 kHz, with approximately 1 V² variance. In order for noise to be considered “white”, its correlation time (Tcorr˜1/Bnoise) must be much shorter (e.g. 10 times) than the duration of the stored bit and, in general, much shorter than any relevant time scale of the system. However, the device operation principle is the same even when this condition is not met. That is, the device can operate keeping the features described in the application in the presence of “white” noise (uniform spectral distribution) or of “colored” noise (non-uniform spectral distribution).

As preferred bistable element one ST is used. Thresholds are set at U₁=−1 V, U₂=+3 V, and output levels are set at Sₒ₁=0 V, Sₒ₂=+2 V. A delay of 1.28 ms is inserted in the loop path. In order to store four bits of information, four consecutive 320 μs pulses with +5 V or −3 V amplitude are injected into the input of the Schmitt trigger depending on whether a “1” or a “0” is meant for storage, respectively. Detection is carried out as follows:
1. the output of the ST is averaged during four consecutive 320 μs intervals;
2. said averages are compared to a fixed threshold set to 1 V, so as to decide if the stored bits correspond to a “1” or a “0” depending on whether the averages are above or below threshold, respectively.

### EXAMPLE 3

FIG. 6 shows a storage device of one or more bits, according to one embodiment of the present invention.

The device consists of a chain formed by one or more similar bistable elements that closes forming a loop. The input signal can consist of one or more binary digits, i.e. the information meant for storage is coded through an amplitude coding system. The input signal can be supra-threshold respect of the first bistable device in the chain. Stored information can be recovered through a detection system at the output of any bistable element. Since the number of bits stored and the duration of each one are fixed known parameters, a possible detection way consists of averaging the output value during a fraction of the time interval corresponding to each binary digit and comparing said average with a threshold.

The duration of each coded binary digit and the number of coded binary digits depend among other factors on the bistable devices response time and the propagation time of a signal along the chain. On the one hand, relevant changes in the input signal must be produced at intervals long enough to allow bistable elements to respond. On the other hand, in order to store more than one binary digit, the time duration for the binary digits sequence must be shorter than or equal to the signal propagation time along the whole chain.

In the present embodiment, the output of the Schmitt triggers is assumed to be sub-threshold, i.e., the output of each ST is not strong enough to force changes in the state of the next bistable element. The novelty of this invention is the ad hoc addition of noise in order to allow the storage of information which would be otherwise impossible under these conditions.

The device of the present invention can store one or more bits thanks to the ad hoc addition of noise at the input of each bistable element in such a way that the output of the previous element plus the added noise surpasses the fixed ST thresholds.

In the particular example of the storage of a single bit, the starting point is a system with added Gaussian noise, having a constant density power spectrum, i.e., a flat, essentially flat power spectrum (variation of less than 3 dB) having a bandwidth Bnoise=10-20 kHz, with a 0.4 V² variance. In order for the noise to be considered “white” its correlation time (Tcorr˜1/Bnoise) must be much shorter (e.g. 10 times) than the duration of the stored bit (e.g. 1 ms) and, in general, much shorter than any relevant time scale of the system. However, the device operation principle is the same even when this condition is not met. That is, the device can operate keeping the features described in the application in the presence of “white” noise (uniform spectral distribution) or of “colored” noise (non-uniform spectral distribution).

As preferred bistable elements two STs are used having thresholds set at U₁=−1 V, U₂=+3 V, and output levels Sₒ₁=0 V, Sₒ₂=+2 V. In order to store one information bit, a 1 ms duration pulse and +5 V or −3 V amplitude, respectively, is injected into the input of one of the Schmitt triggers, depending on if a “1” or a “0” is meant for storage. Detection is carried out as follows:
1. the output of any ST is averaged during 1 ms;
2. said average is compared to a threshold fixed in 1 V, so as to decide if the stored bit is a “1” if the average is higher than threshold, or a “0” in the opposite case.

### EXAMPLE 4

FIG. 7 shows a storage device of one or more bits, according to another embodiment of the present invention.

This outline is similar to the storage device of Example 3, differing in that one or several delay generators are added, their number not being related to the number of bistable elements in the chain. The aim of the delay generators is to allow an increase in the number of binary digits that can be stored in the memory. The delay generator can consist for example of a transmission line sufficiently long for the signal transit time to be noticeable.

In the present embodiment, the output of the Schmitt triggers is assumed to be sub-threshold, i.e., the output of each ST is not strong enough to force changes in the state of the next bistable element. The novelty of this invention is the ad hoc addition of noise in order to allow the storage of information which would be otherwise impossible under these conditions.

The device of the present invention can store one or more bits thanks to the ad hoc addition of noise at the input of each bistable element in such a way that the output of the previous element plus the added noise surpasses the fixed ST thresholds.

In this particular example, the starting point is a system with added Gaussian noise, having a constant density power spectrum, i.e., a flat, essentially flat power spectrum (variation of less than 3 dB) having a bandwidth Bnoise=100-200 kHz, with approximately 1 V² variance. In order for noise to be considered “white” its correlation time (Tcorr˜1/Bnoise) must be much shorter (e.g. 10 times) than the duration of the stored bit and, in general, much shorter than any relevant time scale of the system. However, the device operation principle is the same even when this condition is not met. That is, the device can operate keeping the features described in the application in the presence of “white” noise (uniform spectral distribution) or of “colored” noise (non-uniform spectral distribution).

As preferred bistable element one ST is used. Thresholds are set at U₁=−1 V, U₂=+3 V, and output levels are set at Sₒ₁=0 V, Sₒ₂=+2 V. A delay of 1.28 ms is inserted in the loop path. In order to store four bits of information, four consecutive 320 μs pulses with +5 V or −3 V amplitude are injected to the input of the Schmitt trigger depending on whether a “1” or a “0” is meant for storage, respectively. Detection is carried out as follows:
1. the output of the ST is averaged during four consecutive 320 μs intervals;
2. said averages are compared to a fixed threshold set to 1 V, so as to decide if the stored bits correspond to a “1” or a “0” depending on whether the averages are above or below threshold, respectively.

While at least one presently preferred embodiment of the invention has been described using specific terms, such description is for illustrative purposes only, and it is to be understood that changes and variations may be made without departing from the spirit or scope of the following claims.

1. A device for storing and retrieving one or more binary digits or for increasing persistence time of storage memory for one or more binary digits through Stochastic Resonance, comprising:
a. a circuit with at least one bistable element;
b. means for introducing an input signal into the circuit;
c. means for adjusting the noise level and/or the threshold levels of the bistable elements and/or the output levels of the bistable elements, whereby the input signal, added to the noise signal, surpasses the transition thresholds; and
d. means for detecting the output signal state.

2. A device according to claim 1, whereby said adjusting means are means for introducing an adequate amount of noise signal into the circuit.

3. A device according to claim 1, wherein said adjusting means are means for adjusting transition thresholds of the bistable elements according to the noise level existing in the system.

4. A device according to claim 1, wherein said adjusting means are means for adjusting the output levels of the bistable elements according to the noise level existing in the system.

5. A device according to claim 1, said device comprising means for introducing an adequate amount of noise signal into the circuit, means for adjusting the transition thresholds of the bistable elements and means for adjusting the output levels of the bistable elements, according to the noise level existing in the system.

6. A device for storing and retrieving one or more binary digits through Stochastic Resonance according to claim 1, said device comprising:
a. a circuit with at least one bistable element;
b. means for introducing an input signal into the circuit;
c. means for introducing an adequate amount of noise signal into the circuit for surpassing, added to the input signal, the input threshold; and
d. means for detecting the output signal state.

7. A device for increasing persistence time of memory storage for one or more binary digits through Stochastic Resonance according to claim 1, said device comprising:
a. a circuit with at least one bistable element;
b. means for introducing an input signal into the circuit;
c. means for introducing an adequate amount of noise signal into the circuit for improving the storage persistence time; and
d. means for detecting the output signal state.

8. A device according to claim 1, also comprising means for delaying the signal.

9. A device according to claim 1, wherein said bistable elements are connected in a loop configuration.

10. A device according to claim 1, said device comprising
a. a circuit comprising at least one bistable element arranged in a loop configuration;
b. means for introducing an input signal into the circuit;
c. means for introducing an adequate amount of noise signal into the circuit for surpassing, added to the input signal, the input threshold, if needed, and/or for improving the storage persistence time;
d. means for delaying the signal; and
e. means for detecting the output signal state.

11. A device according to claim 1, said device comprising:
a. a circuit with at least one bistable element;
b. means for introducing an input signal into the circuit;
c. means for adjusting the thresholds and/or the output levels of the bistable elements in such a way as to take advantage of the noise present in the system;
d. means for delaying the signal; and
e. means for detecting the output signal state.

12. A device according to claim 1, wherein said bistable elements are Schmitt Triggers.

13. A device according to claim 1, wherein said input signal is a finite duration signal, preferably a pulse.

14. A device according to any of claims 1, wherein said adjusting means comprise means for introducing an adequate amount of noise signal into the input of each bistable element.

15. A device according to claim 1, wherein said noise signal is Gaussian noise.

16. A method for storing and retrieving one or more binary digits or for increasing persistence time of memory storage for one or more binary digits through Stochastic Resonance, in a circuit comprising at least a pair of bistable elements, the method comprising the introduction of an input signal, the adjustment of the noise level and/or transition threshold signals between bistable elements states and/or the output levels of the bistable elements, whereby the input signal, added to the noise signal, surpasses the transition thresholds; and detecting the circuit output signal.

17. A method according to claim 16, wherein said adjustment comprises the introduction of a noise signal into the circuit.

18. A method according to claim 16, wherein said adjustment comprises the adjustment of the transition thresholds between bistable elements states, according to the noise level existing in the system.

19. A method according to claim 16, wherein said adjustment comprises the adjustment of the output levels of the bistable elements, according to the noise level existing in the system.

20. A method according to claim 16, wherein said adjustment comprises a combination of two or three of the following:
a) introduction of a noise signal into the circuit
b) adjustment of the transition thresholds of the bistable elements states and/or
c) adjustment of the output levels of the bistable elements.

21. A method for storing and retrieving one or more binary digits through Stochastic Resonance, in a circuit comprising at least one bistable element, according to claim 16, wherein said input signal is below the input threshold.

22. A method for storing and retrieving one or more binary digits or for increasing the persistence time of memory storage for one or more binary digits through Stochastic Resonance, in a circuit comprising at least one bistable element, according to claim 16, wherein said input signal is above the input threshold.

23. A method according to claim 16, also comprising delaying the signal.

24. A method according to claim 16, wherein said bistable elements are Schmitt Triggers.

25. A method according to claim 16, wherein said input signal is a finite duration signal.

26. A method according to claim 25, wherein said input signal is a pulse.

27. A method according to claim 16, wherein the coupling between bistable elements, or the self-coupling in the case of a single bistable element in a loop configuration, is not strong enough to force transitions between output states of the bistable elements and said adequate amount of noise signal is introduced to the input of each bistable element.

28. A method according to claim 16, wherein said noise signal is Gaussian noise.
